(19) United States
(12) Patent Application Publication
(10) Pub. No.: US 2024/0152781 A1
(43) Pub. Date: May 9, 2024

(54) RULES DETERMINATION VIA KNOWLEDGE GRAPH

(71) Applicant: SAP SE, Walldorf (DE)

(72) Inventors: Markus Schmidt-Karaca, Heidelberg (DE); Wolfgang Nobeling, Walldorf (DE); Michael Hoerisch, Leimen (DE)

(21) Appl. No.: 18/102,798

(22) Filed: Jan. 30, 2023

Related U.S. Application Data
(60) Provisional application No. 63/423,079, filed on Nov. 7, 2022.

(51) Int. Cl. G06N 5/04

(52) U.S. Cl. CPC G06N 5/04

(57) ABSTRACT

The example embodiments are directed to a host system that can convert human-readable rules (e.g., statutes, regulations, laws, etc.) into a semantic model. The host system can then apply the semantic model to a set of circumstances to determine whether and how the rule applies to the circumstances. In one example, the method may include storing a knowledge graph with a semantic model of a rule embodied therein with nodes representing entities within the rule, edges between the nodes representing relationships between the entities, and identifiers of an input data set used by the rule, receiving input data corresponding to the rule, generating a determination from the rule via execution of the semantic model embodied within the knowledge graph on the received input data, and displaying a notification of the determination via a user interface.

### CROSS-REFERENCE TO RELATED APPLICATION(S)

The present application claims the benefit under 35 USC § 119(e) of U.S. Provisional Patent Application No. 63/423,079, filed on Nov. 7, 2022, in the United States Patent and Trademark Office, the entire disclosure of which is incorporated herein by reference for all purposes.

### BACKGROUND

Rules such as legal regulations are typically embodied in textual form. The rules may state of conditions based on a set of facts or other circumstances. As an example, in order to qualify for unemployment benefits, an applicant must not currently maintain employment and they must have been fired from their previous position of employment. Lengthy software programs and processes are usually required to determine what data needs to be collected from the applicant and other parties involved in order for a decision to be made on whether the applicant qualifies for the benefit. The parties may include the applicant themselves and other entities as well such as previous employers, financial institutions, payroll processors, employment agencies, and the like.

Building such software programs can be a complex process. Often, a developer must hard code the rules and corresponding logic for applying the rules to a set of circumstances into the software programs. Also, the developer must hard code the data inputs and the data outputs. For example, the developer may define how data is collected and what set of circumstances or conditions must be present within the input data for a particular decision to be made by the software for each particular possible output of the rule. In this rigid setting, all of the rules must be hardcoded into the software program otherwise errors will occur. But writing programming code consumes a significant amount of time and usually requires a skilled technician which is a considerable cost.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a process for converting text-based rules into a knowledge graph in accordance with example embodiments.

FIG. 1B is a diagram illustrating a process of a applying rules within the knowledge graph to a set of circumstances in accordance with example embodiments.

FIG. 2 is a diagram illustrating a host service for generating decisions based on rules using a knowledge graph in accordance with example embodiments.

FIG. 3 is a diagram illustrating a rule that has been modeled and stored within a knowledge graph in accordance with an example embodiment.

FIG. 4 is a diagram illustrating an architecture of a user interface interacting with a knowledge graph in accordance with an example embodiment.

FIG. 5 is a diagram illustrating a method of determining a rules-based decision via a knowledge graph in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The example embodiments are directed to a host platform that can translate text-based regulations such as those stored in a document into a machine-readable format embodied in a knowledge graph. As described herein, a knowledge graph is a semantic graph that integrates semantic information. Within the knowledge graph, entities are things represented as nodes with associations therebetween which are represented by edges. The modeled rule within the knowledge graph/ontology may include identifiers of input data that is necessary for the software to apply the rule. For example, the software may determine whether all of the necessary input data for the different elements of the rule have been received. In this example, an inference engine may analyze the modeled rule within the knowledge graph to identify if any values are still needed, query a user/system for such values, and complete the data collection process. Furthermore, the inference engine may detect when the data necessary for the rule is there, and apply the rule based on the model stored in the knowledge graph. The determination can be provided to the requesting software application. Thus, the entire process of applying “human-readable” rules to a set of facts may be completely automated and processed using computer hardware processors that have machine-reading capabilities using the knowledge graphs with semantic technologies embedded therein.

The host process described herein includes semantic technologies such as knowledge graphs and related standards for translating a rule stored in a document such as an electronic document with human-readable text (e.g., JSON, CSV, XML, etc.) into a knowledge graph that includes nodes interconnected with edges. The host process may execute a rule modeled in the knowledge graph on input data to materialize an outcome of the rule. For example, a user may upload one or more rules in document form to the system. In response, the system may translate the rules into a machine-readable form (e.g., as a graph in which nodes represent entities from the rule and edges interconnecting the nodes represent relationships and dependencies between the entities, etc.)

As another example, the machine may also assist the user in translating the rules into machine-readable format requesting the user to make any final adjustments or refinements and approve of the translation. For example, the host platform may provide a development environment where the rules can be uploaded in document form and translated into the knowledge graph. The translation may be performed using an ontology which may also be in graph form. For example, a host service described herein may receive input values and pass the input values to a knowledge graph system. The knowledge graph system includes a knowledge graph with rules encoded therein and an inference engine that can execute inputs received via the knowledge graph to determine apply the rule to a set of facts/input data. The knowledge graph system receive the input data and determines whether the input data satisfies all the necessary data for making a decision/determination based on a particular rule. If there is enough information, the service can execute the rule via the knowledge on the input data to generate a determination (e.g., Yes or No, etc.).

As another example, the development environment may provide a user interface with a workspace that enables a user such as a developer to modify the ontology. The ontology provides a mechanism for “modeling” rules including the inputs, outputs, etc., without having to “hard code” such rules into the corresponding program code. By doing so, the application of the rules becomes more flexible. For example, rules can be changed in the ontology without having to touch the programming code of a software application that needs to the rules applied. This can save significant time for developers and programmers because they no longer need to hard code such rules, or keep track of changes to such rules.

The knowledge graph is designed with the rules in machine-readable format. Each rule may be modeled such that the inputs are identified, the output is identified, and the requirements for determining an output from the input may be modeled. In this example, the host platform can identify if there is any data that still needs to be collected from a rule based on the model in the graph before a decision can be made. If necessary, the host platform can generate a user interface, send a request or query to another system, and the like, to perform data collection to collect any missing data. The host platform may also perform data validation. The host platform can use an inference engine to apply the rules in graph form to input data (e.g., a set of circumstances, details, facts, etc.) to generate decisions via a data driven process. In these examples, the host platform may detect which data needs to be collected, in which order, and from whom, and ensures the host process continues to run until all data necessary to apply the rule has been completed.

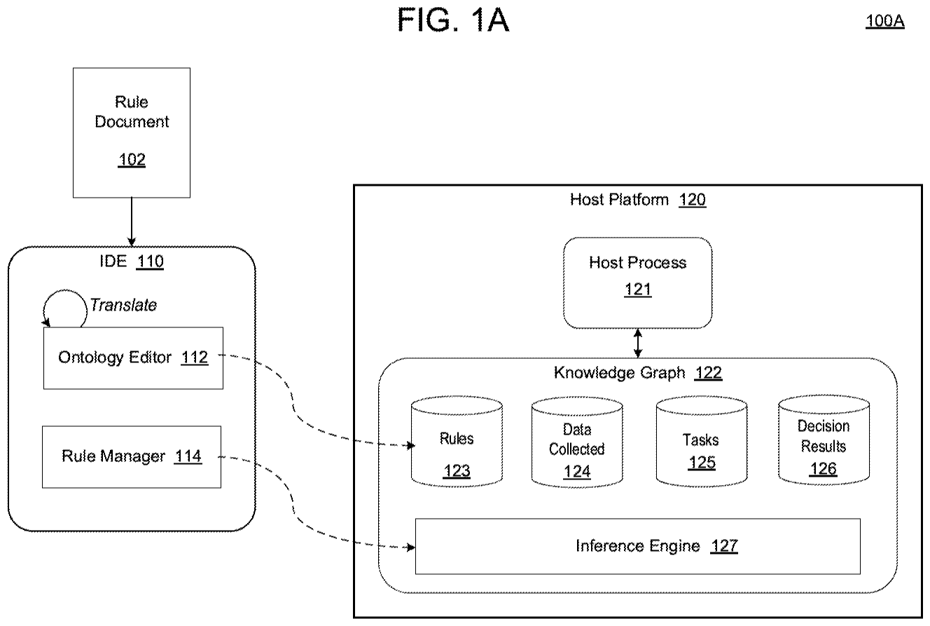

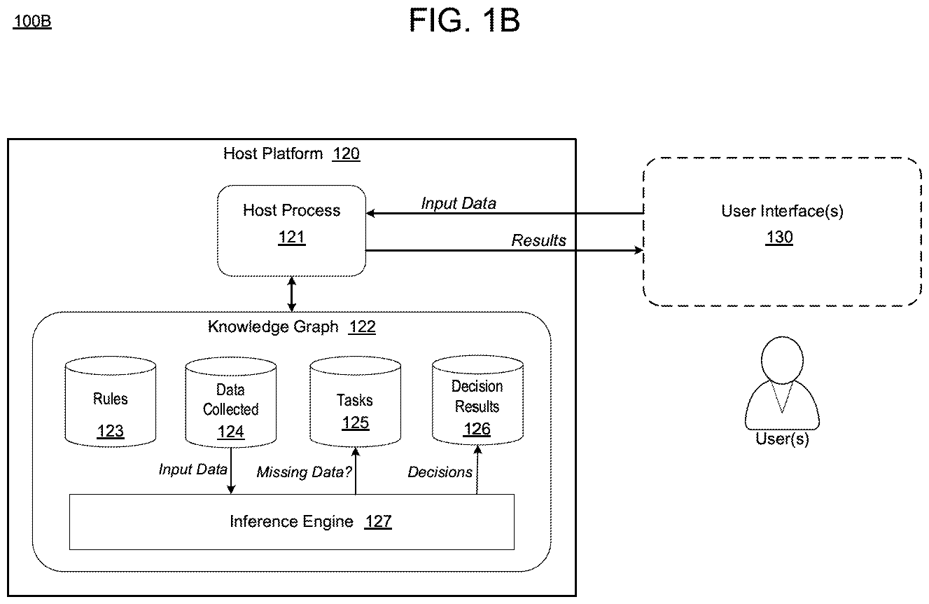

FIG. 1A illustrates a process 100A for converting text-based rules into a knowledge graph 122 in accordance with example embodiments, and FIG. 1B illustrates a process 100B of a applying rules within the knowledge graph to a set of circumstances in accordance with example embodiments. Referring to FIG. 1A, a host platform 120 hosts a host process 121 that manages a decision making process performed by the host platform 120. The decision making process involves applying a rule or rules to a set of circumstances (e.g., a set of facts, etc.) The rules can be translated from a textual format into a machine-readable form (semantic model) in a graph format that can be read by a machine such as a microprocessor. The semantic model of the rule can be added to a knowledge graph 122 which can be used by the host process 121 to make determinations in an automated manner.

The interaction with the host platform 120 has two phases including a design phase and a runtime phase. During the design phase, rules may be converted from traditional textual format into the knowledge graph 122. The rules may include legislative rules or other rules embodied in documents, web pages, files, or the like, which can be submitted to the host platform 120 via the IDE 110 over a network communication such as an upload from a user interface, an electronic communication, an API request, etc.

Each rule may define the input data necessary, and the conditions necessary to arrive at a particular decision based on a rule. During the design phase, a regulatory document 102 with a rule described therein may be translated into machine readable form using semantic modeling and natural language processing (NLP). The IDE 110 may include tools to manage the design phase including an ontology editor 112 and a rule manager 114. The ontology editor 112 can be used to edit an ontology that is stored within rules 123 of the knowledge graph 122. The ontology may contain data that is the basis of the decision rules. It consists of concepts (classes) and the relations between them (object properties). As an example, a rule may include requirements for a set of circumstances or conditions to be present in order for the rule to output a particular decision. The attributes can be any kind of attribute such as income level, number of dependents, gender, age, familial relationships, and the like.

The rules may also be modeled. They act on the data (e.g., from individuals, etc.) which would be created based on the ontology. Rules can be logical, or constraint based. The rule manager 114 can be used to model the rules 123 into semantic form such as a graph model in which entities from the rule such as keywords, etc., are represented as nodes and edges between the nodes identify relationships between the entities. There may be different types of rules, but all of them may be formulated and handled based on the same open standards.

For example, decision rules may create a decision/outcome. Reusable rules may create intermediate results like the decision rules. Their output can become input to other rules (or reusable rules) and allow a better reuse or segregation of rules for better clarity. Other rules may include data completeness rules that have a generic structure and go along with the decision rules to analyze the existence and completeness of the data set being input into the system for use with the decision rules. Absence or incompleteness of data would lead to the creation of a task object which holds information about the data owner who should be asked to provide the data. Here, the host process 121 may identify which data is missing and create tasks for collecting that data in some way such as through an electronic communication, a user interface being displayed, an API request, and the like, until enough data is collected to be able to make the decision.

Referring now to FIG. 1B, at runtime, the knowledge graph 122 can be accessed and used to make determinations based on rules that have been translated and embodied within the knowledge graph 122. Necessary data can be input to the host platform 120 and collected and stored within a data store 124. The data stored within the data store 124 may then be used to determine whether the data applies to a rule, and if so, what the decision is. The data stored within the data store 124 may also be used for a completeness check to ensure that all necessary data is present.

In some embodiments, the knowledge graph 122 may be a Resource Description Framework (RDF) triple store which is a type of graph database that stores semantic facts. The triple store may store data as a network of objects (nodes) with links (edges) between them. Each of the nodes in the knowledge graph 122 may be part of a triple in its function as a subject or an object. The edges are the predicates. The subject may represent a concept that is relevant to describe the circumstantial data, the predicate may represent the relation to another concept within the rule, and the object may represent another concept that is relevant to the circumstantial data.

Through an inference engine 127 built within the knowledge graph database which applies input data to rules in the knowledge graph 122 to infer rule results and materialize the results as new individuals into the knowledge graph itself. The inference engine 127 works based on logical standards and may not contain any knowledge about the decision subject itself. Hence with a fully generic implementation of the inference engine 127, the outcomes of the decision making only depend on the rules given as input to the inference engine 127 and not on the logic of the inference engine 127 itself.

In some embodiments, the inference engine 127 may detect whether any of the necessary data for applying the rule is missing. For example, the data necessary for the rule may be stored within the knowledge graph 122. Absence or incompleteness of data would lead to the creation of a task object which can be stored in a task database 125 and which holds information about the data owner who should be asked to provide the data. The task may be converted into an electronic message that is sent to the data owner or a user interface pop-up or window that is displayed on a device of the data owner.

Along with the above-mentioned three types of rules the inference engine 127 will produce three types of results. Those results themselves are materialized into the knowledge graph 122 and do not differ structurally from the other data. For example, the results may include decision results, intermediate knowledge that can be reused by other rules, and tasks. The decision results and intermediate knowledge may be stored within a decision data store 126. The decision data store 126 is structurally not different from the data store 124 that is used for data collection. This enables decision results to be inferred (e.g., logical conclusions, etc.) from the data stored in the decision data store 126 which had intrinsically been contained in the data collected in the data store 124 and only have been inferred to become explicit. Data that was collected from the data owners and stored within the data store 124 can be considered as input to the inference engine 127. Furthermore, any missing or incomplete data can generate tasks which are stored in a task database 125 and subsequently scheduled by the host process 121.

In addition, the host platform 120 may also output one or more user interfaces 130. The one or more user interfaces 130 may include one or more user interfaces for the data collection which can be used by data owners to provide specific triples as known to the data owner. Several data owners can provide different pieces of the whole data set and they do not have to do it in a fixed sequence. These user interfaces will write data to the knowledge graph 122. They may use standards such as SPARQL for accessing the knowledge graph.

As another example, the tasks that are created based on missing but expected data can be output on the one or more user interfaces 130 to request the data owners to provide the missing data. The tasks may also contain a link to the one or more user interfaces 130 that enable data input on exactly the data requested by the task. The task lists can select all task for a data owner. Hence the task list gives a structure to the data input requests for one data owner. It will automatically end up as a dynamic form which only request data, that is not there yet and that is requested by one data owner. The one or more user interfaces 130 may also display decisions made by the knowledge graph 122. The data driven process does not need to be explicitly modeled as it evolves automatically through permanent rule execution that generates tasks until all data is provided and decisions can be made by the inference engine 127.

At runtime, the one or more user interfaces 130 may be generated based on the ontology with only little input from a designer. For example, mechanisms such as CAP (Cloud Application Programming) may be extended. Handlers may be used to extend the capabilities of service generation for UI interactions in a way that those services can use SPARQL and write or read to knowledge graph 122. One of the advantages of this solution is that the designers only need to model ontology and rules for new decisions while the remaining processes of data collection and decision making evolves without additional code. The solution saves developers significant amounts of development time since the translation and application of text-based rules is performed via a knowledge graph which is machine-readable.

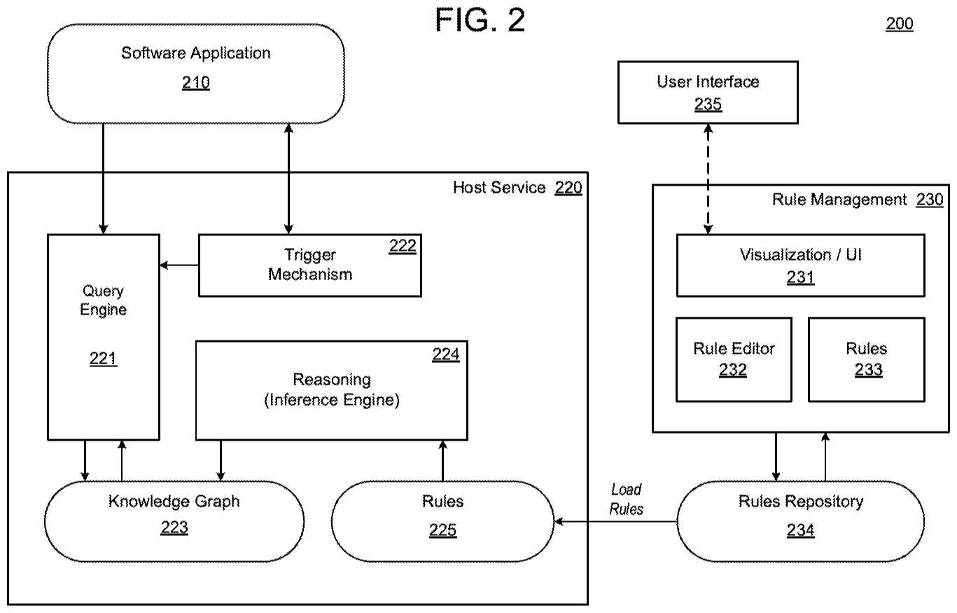

FIG. 2 illustrates a process 200 of a host service 220 generating decisions based on rules using a knowledge graph 223 in accordance with example embodiments. The host platform 120 that is described in the example of FIGS. 1A and 1B may be integrated into the host service 220, referred to herein as a “knowledge graph as a service” or “knowledge as a service.” The host service 220 may include the same components from both the design time phase and the runtime phase of the host platform 120 described in the examples of FIGS. 1A and 1B.

Referring to FIG. 2, the host service receives user data and user requests for rules application from a software application 210. The software application 210 may be an application where the rules within the knowledge graph 223 can be applied to make decisions for the software application 210 such as whether a rule is applicable to a set of circumstances and how the rule applies based on conditions in the input data. The rules can be stored within a rules repository 234 to begin with. Also, rules can be added to the repository 234 from various sources such as third-party database, and the like. Also, new rules can be created by a user via rule management system 230. Here, the rule management system can generate a visualization 231 of an ontology and/or the knowledge graph 223. The user can then use a rule editor 232 to create new rules 233 which can be stored in the rules repository 234 and added to the knowledge graph 223. The newly created rules may be created in graph format (semantic model).

When a new query or rule request is received from the software application 210, the host service 220 may compare the rules stored within the knowledge graph 223 to determine if and how any of the rules apply to the set of circumstances. The determination can be made by a reasoning component 224 which may include the inference engine 127 described in FIGS. 1A and 1B. The reasoning component 224 may compare the set of circumstances to the graph model of the rule to determine how the rule applies to the set of circumstances. To do this, the host service 220 may model the different attributes of a rule as different triples in the graph model which is related to both the input data from the software application 210 and the rule stored in the knowledge graph 223. It can include a relation to the data that is used by the rule, the dependency to the output of outer rules and the URI that points to a repository location that stores the actual code of the rule. For example, a query engine 221 may traverse the knowledge graph 223 for patterns that fit a rule from among the rules that are stored in the knowledge graph 223 (as graph models). If a pattern is a match, then an applicable rule is detected and executed to derive a decision based on the rule applied to the set of circumstances. The rule may include conditions and other value that provide a deterministic mechanism for applying the rule.

The rules stored in the rules repository 234 may be loaded into a rules data store 225 and translated into the knowledge graph 223 by the reasoning component 224 (e.g., the inference engine, etc.). The static data that describes the circumstances of the user/applicant may also be modeled within the graph. For example, a regulatory document (which can be a legislation document) will be analyzed first for key concepts and terms which will form the classes of an ontology. Next the relations between the classes will be extracted and translated into object properties of the ontology. The created ontology forms the static data model of the circumstances of the applicants on which the decision is to be made.

The data model is a semantic model in which nodes (triples) represent different entities within the rule, and edges (lines) between the nodes represent dependencies and other relationships among the entities of the rule. Each little fact or atomic knowledge can be expressed as a triple of the form subject—predicate—object, where subject and object are classes and predicate is an object property. The superset of all those triples forms the knowledge graph 223. The knowledge graph 223 is extensible at any time without disruption by just adding new triples. The host service 220 may also include a trigger mechanism 222 which can detect when a data request needs to be sent and how to send it based on tasks generated by the inference engine stored within the reasoning component 224. For example, the reasoning component 224 may store tasks in a queue or other scheduler with details of how the data should be collected (e.g., via a user interface, email, instant message, phone call, etc.), and any additional data that can be used to help collect the data such as a URL or IP address of the user interface and/or the contact information of the user.

The modeling of the ontology can be done by any editor that is compliant with underlying open standards. It can but does not have to be supported by a dedicated user interface of the host platform. In addition, NLP techniques can be added to analyze the regulatory text and provide a first draft version of the model automatically which a user can then visualize and make changes to via the user interface 235 of the rule management system 230. One advantage of this process is that the model will contain the circumstance data for all decisions that shall be made. Hence if there is an overlap of data used for multiple decisions, the model and the collected data can be reused.

Consent of a data owner to reuse the data provided for the purpose of one decision for a second decision can be modeled as part of the same knowledge graph and can be considered as part of the rule conditions. This additional consent data can be checked and/or otherwise processed to verify compliance with data privacy regulations.

In some embodiments, the rules may be formulated as logical or constraint-based deductions on the data. This is known as inference in the context of semantic technologies. There are open standards for semantic technologies that can be used to formulate such rules. The inference engine within the reasoning component 224 can apply the rules on the knowledge graph 223 and materialize the results as new knowledge. Hence decisions are just new instances in the knowledge graph 223. Through the use of open standards, no proprietary knowledge is required for the formulation of rules. Also, the execution on an inherence engine that generically acts on the knowledge graph can be a purely standards-based application.

Rules stored in the rules repository 234 and ingested by the host service 220 may be created and managed in a way that allows multiple teams to work on the rules for a new decision with a timeframe opposed by the regulation policy rather than by any upgrade time frames of a software system. The may be extensible at any time and may be able to be reused at least partially for new decisions. Hence some tooling is required to support this. A rule will also be managed through the knowledge graph. For this it will be represented by a class that keeps a reference to the rule code and further attributes to manage the rules.

The rule repository 234 may be linked to the information about which decision the rules support and about the dependency to the ontology and to other rules. This information about the rules and the location in the repository would be stored using the techniques of a knowledge graph 223. The starting point of an editing user is this visualization of the knowledge graph 223 via a visualization component 231 that gives the user a view of the relevant rules in the context of their purpose via the user interface 235. From there the user may navigate into the rule editor 232 that then loads individual rules form the repository 234. The rule editor may access a file, manipulate it, and write it back to the repository to which a link is kept in the knowledge graph 223. In some embodiments, the inherence engine may load all active rules and execute them all. The knowledge graph keeps the reference to those individual files.

Rule may produce materialized inference results that can be used as input for other rules. This gives a modularization on one side and the option to reuse rules of a more generic purpose for multiple decisions. These rules may be referred to a sub-rules, partial rules, rule components, or the like. These sub-rules can be reusable with multiple other larger rules. Rules may also have dependencies to classes in the underlying ontology within the knowledge graph 223 and to other rules. Dependencies to classes by all classes used in the condition of the rule. The dependency to other rules is indirect as those rules would result in a materialized new class that is being used by the rule.

The inference engine within the reasoning component 224 can operate on the triple store at good performance. The inference engine itself may execute the rule on the knowledge graph 223 based on the data values in the set of circumstances. At runtime all active rules are loaded and are being executed in a mode where always all rules are applied to the whole knowledge graph iteratively. Hence nobody must organize when which rule is getting executed. However, there may be performance optimized algorithms that analyze the dependencies within the rules and the changes applied to the knowledge graph since last execution to reduce the load on the processor and keep the performance up.

Once the design time tasks are done and the ontology which forms the data model for the decision data and the rules are defined, the knowledge graph may be populated with individuals (data values) for all those entities. This requires user interfaces to populate the knowledge graph with those individuals. Decision rules can only be executed when there is data in the knowledge graph. This actual data is referred to as individuals in the jargon of semantic technologies. Data input shall also rely on standards. In this case that would be semantic queries via a semantic query language such as SPARQL or the like which enable reading and writing triples and adding them into a knowledge graph.

When a data owner is asked to provide some additional data, the data owner does not need to see the entire knowledge graph. Here, the user interface can display identifiers of the missing data in a simple way. For example, only the missing data values and fields for storing the corresponding values may be displayed on the user interface. As another example, a small portion of the knowledge graph can be displayed with the missing input fields highlighted in a different color such as yellow or the like. The host service 220 may translate the ontology into artefacts that are needed to build a UI on top including a data model of the rule, service generation for communication between frontend and backend, a user interface itself, a service implementation that interprets an ODATA request coming from the user interface into a SPARQL query that updates the knowledge graph 223, and the like.

Linked to each decision within the knowledge graph 223 may be a set of tasks as a standardized part of the model. For example, a set of rules may be provided that create such a task if the data needed for a decision is missing and the decision making has been requested (i.e. through the software application 210 which itself forms the request to make a decision). The tasks may have set of standardized data properties that indicate who is the data owner who is to provide the data. The task may also have a link to a user interface that is generated so that it provides those triples that are missing to the knowledge graph 223.

As another example, data collection would be requested through a task. The tasks itself may be exposed through the user interface 235 to the data owner who is requested to provide the data. Through SPARQL statements the tasks can be selected with the condition filter by data owner. Hence a generic user interface called task inbox would first ask a data owner for authentication, then the data owner is known, and tasks can be filtered by the data owner. If there are tasks, the data owner would see them and get the link to the respective user interface where the user can provide the missing data. Any other mechanisms to trigger the notification of a data owner such as mail, telephone call, visit of a case worker, or the like, may also be detected by the trigger mechanism 222.

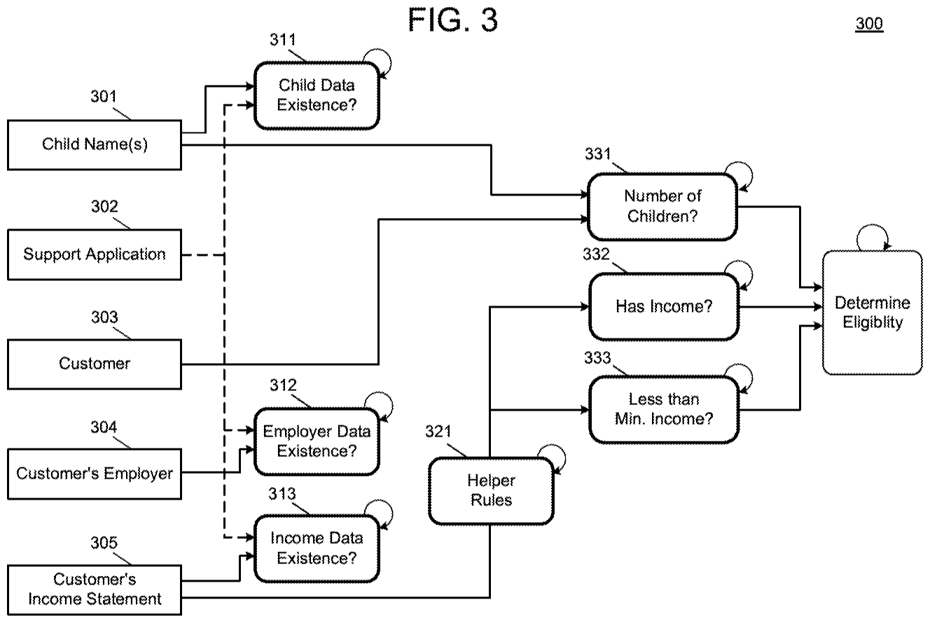

FIG. 3 illustrates an example of a rule 300 that has been modeled via a semantic modeling language and stored within a knowledge graph in accordance with an example embodiment. In this example, the rule 300 is a rule for determining whether an applicant is eligible for child support. The rule has three different requirements (e.g., from a statute, etc.) in this example including (i) there must be at least one child, (ii) the supporting spouse must have at least a predefined minimum amount of income, and (iii) the receiving spouse must have an income amount below a threshold. In this example, the requirements 331, 332, and 333 can be modeled as nodes in the knowledge graph that can be applied by the rule 300 when executed by the inference engine.

Meanwhile, the rule also includes input sources 301, 302, 303, 304, and 305 where input data may be received from for the rule. In this example, the input sources 301, 302, 303, 304, and 305 may include content that is input from a user interface using buttons, fields, checkboxes, etc. As another example, the input sources 301, 302, 303, 304, and 305 may be include forms, documents, files, etc., which can be uploaded to the host platform in a form that does not need to be input to a user interface. In this example, input source 303 is an electronic form that can be filled out by an applicant for child support and input sources 301, 302, 304, and 305 correspond to input fields on a user interface.

According to various embodiments, the rule 300 may include various sub-rules that can be reusable across different rules. In the example of FIG. 3, a first set of sub-rules includes rules 311, 312, and 313 which check whether data values are present from the input sources 301-305. In this example, it is not necessary that each of the input sources 301-305 provide data. However, it is necessary the values necessary for applying the rule 300 be present. Here, the rule 311 can check that all necessary child/dependency information is uploaded to the system, the rule 312 can check that all necessary employer data (pay stubs, etc.) have been uploaded to the system, and the rule 313 can check whether the applicant has input anything for income. The input source 302 may also provide the missing data and may be checked as well. If any of the checks performed by the inference engine applying the rules 311, 312, and 313 to the input sources 301-305 detect a needed data value this missing, a data request may be submitted to a data owner or a database where such data can be retrieved.

In the example of FIG. 3, the rule 300 also includes helper rules 321 which can massage the income data from any of the input data sources 302, 304, and 305, to identify whether the applicant has any income and if so, if their income is less than the requirement for child support. When the inference engine determines that all data necessary for applying the rule is present, the inference engine may execute the rule 300 embodied in the knowledge graph on the input data values from the input sources 301, 302, 303, 304, and/or 305 and determine a result based on the input data. For example, each of the requirements 331, 332, and 333 may be checked to make sure they are satisfied. If all three requirements 331, 332, and 333 are satisfied, then the determination by applying the rule may be a “YES” in which case the applicant is entitled to child support. Otherwise, the determining by applying the rule is a “NO” and the applicant is not entitled to child support.

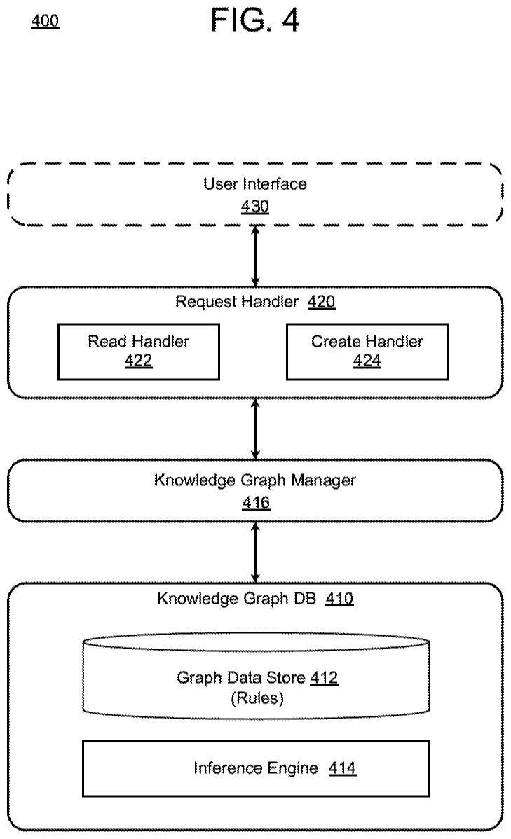

FIG. 4 illustrates an architecture 400 of host platform that includes a knowledge graph and a user interface interacting with the knowledge graph in accordance with an example embodiment. Referring to FIG. 4, the architecture 400 includes a knowledge graph database 410 that includes a data store 412 such as a graph-data store, triple store, and the like, which can display data on a user interface 430 and which can store data input from the user interface 430. The knowledge graph database 410 also includes an inference engine 414 that can apply a set of input data to a rule embodied within the knowledge graph inside the data store 412. For example, the inference engine 414 can traverse the nodes and edges in the graph and execute sub-rules and checks to make sure the data is present, any helper rules are applied, and a decision is made based on the rule as a whole.

The architecture 400 also includes a request handler 420 for receiving data from the user interface 430 and/or outputting data on the user interface 430. Furthermore, the request handler 420 can read data from the knowledge graph database 410 via read handler 422, query the knowledge graph database 410, and write to the knowledge graph database 410 via the create handler 424. The knowledge graph manager 416 may manage the interaction between the request handler 420 and the graph data store 412 and the inference engine 414 within the knowledge graph database 410.

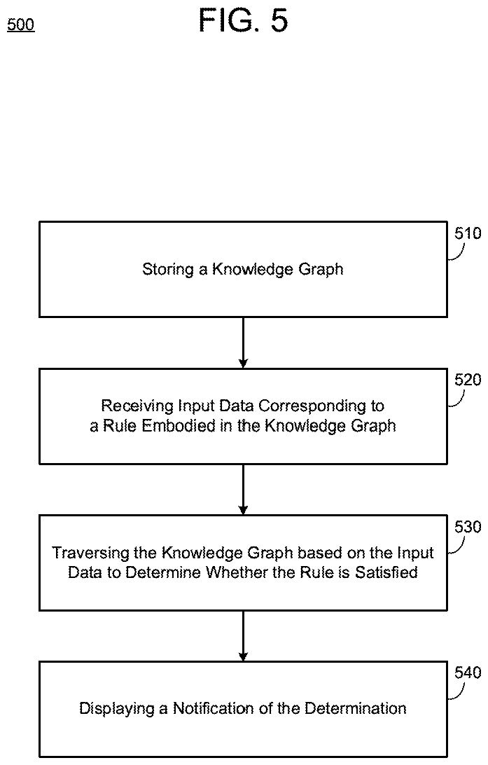

FIG. 5 illustrates a method 500 of determining a rules-based decision via a knowledge graph in accordance with an example embodiment. For example, the method 500 may be performed by an inference engine within a knowledge graph hosted by a database node, a cloud platform, a server, a computing system (user device), a combination of devices/nodes, or the like. Referring to FIG. 5, in 510, the method may include storing a knowledge graph with a semantic model of a rule embodied therein. For example, the semantic model embodied within the knowledge graph may include a plurality of nodes representing a plurality of entities within the rule, respectively, edges between the nodes representing relationships between the entities, and identifiers of a data set that is to be input to the rule and that is required/necessary for the software to trigger the application of the rule.

In 520, the method may include receiving input data corresponding to the rule. In 530, the method may include generating a determination from the rule via execution of the semantic model embodied within the knowledge graph on the received input data. In 540, the method may include displaying a notification of the determination via a user interface. In some embodiments, the method may further include determining that the received input data is missing data necessary to apply the rule based on the semantic model of the rule embodied in the knowledge graph, and generating and transmitting data requests to one or more of a user interface and a computing terminal to collect missing data to generate the complete data set. In some embodiments, the method may further include generating a user interface with input controls for collecting the missing data and displaying the user interface on a computing terminal of a corresponding data owner of the missing data.

In some embodiments, the method may further include generating the semantic model of the rule via a plurality of interconnected triples stored in the knowledge graph, where each triple includes a subject corresponding to a keyword from the rule, a predicate corresponding to a property of the keyword, and an object corresponding to another keyword from the rule. In some embodiments, the method may further include translating a human-readable version of the rule into a machine-readable semantic model based on an ontology of the knowledge graph.

In some embodiments, the method may further include receiving, via a user interface, inputs configuring the ontology of the knowledge graph. In some embodiments, the semantic model of the rule may include a plurality of reusable sub-rules corresponding to the rule, wherein each reusable sub-rule comprises a different semantic model in the knowledge graph. In some embodiments, the method may further include the traversing comprises querying the knowledge via a semantic query language to determine whether the set of circumstances satisfy requirements of the semantic model of the rule stored within the knowledge graph.

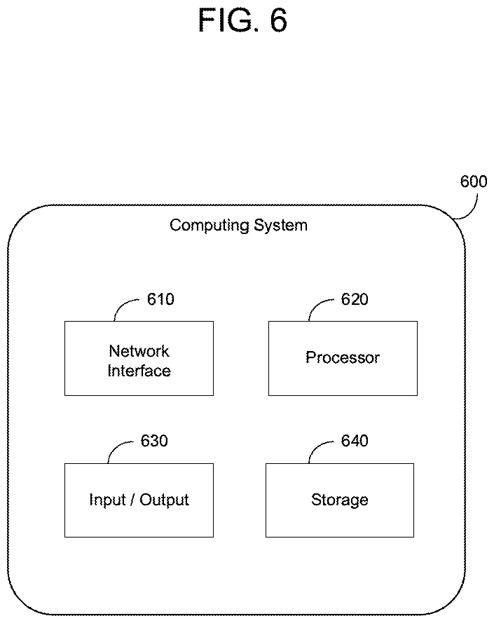

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the methods described herein. According to various embodiments, the storage 640 may include a data store having a plurality of tables, records, partitions and sub-partitions. The storage 640 may be used to store database records, documents, entries, and the like.

According to various embodiments, the storage 640 may be configured to store a knowledge graph with one or more rules embodied therein. Each rule may include requirements of the input data that must be present for the rule to be executed. For example, each semantic model embodied within the knowledge graph may include nodes that represent entities within a rule, edges between the nodes that represent relationships between the entities, and identifiers of a data set required to be present by the rule. The processor 620 may be configured to receive input data corresponding to the data set, traverse the knowledge graph via an inference engine based on the input data and applying the semantic model of the rule stored within the knowledge graph to the input data to generate a determination, and display a notification of the determination via a user interface.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a knowledge graph with a semantic model of a rule embodied therein, wherein the semantic model embodied within the knowledge graph comprises nodes that represent entities within the rule, edges between the nodes that represent relationships between the entities, and identifiers of a data set used by the rule; and
a processor configured to
receive input data corresponding to the data set,
traverse the knowledge graph via an inference engine based on the input data and applying the semantic model of the rule stored within the knowledge graph to the input data to generate a determination, and
display a notification of the determination via a user interface.

2. The computing system of claim 1, wherein the processor is configured to determine that the received input data is missing data necessary to apply the rule based on the semantic model of the rule embodied in the knowledge graph, and generate and transmit data requests to one or more of a user interface and a computing terminal to collect missing data to generate a complete data set.

3. The computing system of claim 2, wherein the processor is configured to generate a user interface with input controls to collect the missing data and display the user interface on a computing terminal of a data owner that corresponds to the missing data.

4. The computing system of claim 1, wherein the processor is further configured to generate the semantic model of the rule via a plurality of interconnected triples stored in the knowledge graph, where each triple includes a subject corresponding to a keyword from the rule, a predicate corresponding to a property of the keyword, and an object corresponding to another keyword from the rule.

5. The computing system of claim 1, wherein the processor is further configured to translate a human-readable version of the rule into a machine-readable semantic model based on an ontology of the knowledge graph.

6. The computing system of claim 5, wherein the processor is further configured to receive, via a user interface, inputs that configure the ontology stored of the knowledge graph.

7. The computing system of claim 1, wherein the semantic model of the rule comprises a plurality of reusable sub-rules corresponding to the rule, wherein each reusable sub-rule comprises a different respective semantic model embodied within the knowledge graph.

8. The computing system of claim 1, wherein the processor is configured to query the knowledge graph via a semantic query language to determine whether the input data satisfies requirements of the semantic model of the rule embodied within the knowledge graph.

9. A method comprising:
storing a knowledge graph with a semantic model of a rule embodied therein, wherein the semantic model embodied within the knowledge graph comprises nodes representing entities within the rule, edges between the nodes representing relationships between the entities, and identifiers of a data set used by the rule;
receiving input data corresponding to the rule;
generating a determination from the rule via execution of the semantic model embodied within the knowledge graph on the received input data; and
displaying a notification of the determination via a user interface.

10. The method of claim 9, wherein the method further comprises determining that the received input data is missing data necessary to apply the rule based on the semantic model of the rule embodied in the knowledge graph, and generating and transmitting data requests to one or more of a user interface and a computing terminal to collect missing data to generate a complete data set.

11. The method of claim 10, wherein the method further comprises generating a user interface with input controls for collecting the missing data and displaying the user interface on a computing terminal of a corresponding data owner of the missing data.

12. The method of claim 9, wherein the method further comprises generating the semantic model of the rule via a plurality of interconnected triples stored in the knowledge graph, where each triple includes a subject corresponding to a keyword from the rule, a predicate corresponding to a property of the keyword, and an object corresponding to another keyword from the rule.

13. The method of claim 9, wherein the method further comprises translating a human-readable version of the rule into a machine-readable semantic model based on an ontology of the knowledge graph.

14. The method of claim 13, wherein the method further comprises receiving, via a user interface, inputs configuring the ontology of the knowledge graph.

15. The method of claim 9, wherein the semantic model of the rule comprises a plurality of reusable sub-rules corresponding to the rule, wherein each reusable sub-rule comprises a different semantic model embodied within the knowledge graph.

16. The method of claim 9, wherein the generating comprises querying the knowledge graph via a semantic query language to determine whether the input data satisfies requirements of the semantic model of the rule embodied within the knowledge graph.

17. A non-transitory computer-readable medium comprising instructions which when executed by a processor cause a computer to perform a method comprising:
storing a knowledge graph with rules embodied therein, wherein each rule within the knowledge graph comprises nodes representing entities within the respective rule, edges between the nodes representing relationships between the entities, and identifiers of a data set used by the respective rule;
receiving input data corresponding to a rule in the knowledge graph;
traversing the knowledge graph via an inference engine based on the input data and applying a semantic model of the rule embodied within the knowledge graph to the input data to generate a determination; and
outputting a notification of the determination via a user interface.

18. The non-transitory computer-readable medium of claim 17, wherein the method further comprises determining that the received input data is missing data necessary to apply the rule based on the semantic model of the rule embodied in the knowledge graph, and generating and transmitting data requests to one or more of a user interface and a computing terminal to collect missing data to generate a complete data set.

19. The non-transitory computer-readable medium of claim 18, wherein the method further comprises generating a user interface with input controls for collecting the missing data and displaying the user interface on a computing terminal of a corresponding data owner of the missing data.

20. The non-transitory computer-readable medium of claim 17, wherein the method further comprises generating the semantic model of the rule via a plurality of interconnected triples stored in the knowledge graph, where each triple includes a subject corresponding to a keyword from the rule, a predicate corresponding to a property of the keyword, and an object corresponding to another keyword from the rule.
